(19) United States
(12) Patent Application Publication
(10) Pub. No.: US 2016/0242433 A1
(43) Pub. Date: Aug. 25, 2016

(54) MARSHMALLOW TREAT AND METHODS FOR FORMING A MARSHMALLOW TREAT

(71) Applicant: TARA J. SCHWENKER, Waldwick, NJ (US)

(72) Inventor: TARA J. SCHWENKER, Waldwick, NJ (US)

(21) Appl. No.: 15/041,071

(22) Filed: Feb. 11, 2016

Related U.S. Application Data
(60) Provisional application No. 62/151,176, filed on Apr. 22, 2015.
(60) Provisional application No. 62/118,697, filed on Feb. 20, 2015.

(51) Int. Cl. A23G 3/54; A23G 1/54; A23G 1/30; A23G 3/34; A23G 3/52

(52) U.S. Cl. CPC A23G 3/545; A23G 3/0065; A23G 3/52; A23G 1/305; A23G 1/545; A23V 2002/00

(57) ABSTRACT

A marshmallow treat includes a core which contains or is infused with one or more fillings. The marshmallow treat includes an infused center and an inner flash frozen layer sealing the fillings of the hollow center. A partially fluffed marshmallow layer surrounds and is disposed on an outside of the inner flash frozen layer. The marshmallow layer is surrounded by an outer flash frozen layer. The outer flash frozen layer surrounds and seals the marshmallow layer.

### CROSS-REFERENCE TO RELATED APPLICATIONS

This application claims priority from U.S. Provisional Patent Application No. 62/118,697, filed on Feb. 20, 2015 and U.S. Provisional Patent Application No. 62/151,176, filed Apr. 22, 2015, the disclosure of which is incorporated by reference herein in its entirety.

### TECHNICAL FIELD

Exemplary embodiments of the present invention relate to a marshmallow treat and methods for forming a marshmallow treat. More particularly exemplary embodiments of the present invention relate to a marshmallow treat with an infused core for being heated on an open fire or an open flame.

### SUMMARY

Exemplary embodiments of the present invention provide a marshmallow treat including a core which contains or is infused with one or more fillings. The marshmallow treat includes an infused center and an inner flash frozen layer sealing the fillings of the hollow center. A partially fluffed marshmallow layer surrounds and is disposed on an outside of the inner flash frozen layer. The marshmallow layer is surrounded by an outer flash frozen layer. The outer flash frozen layer surrounds and seals the marshmallow layer.

The one or more fillings may include, for example, a cracker, candy, butterscotch, caramel, mint, vanilla, peanut butter, hazelnut, lemon, orange, or coconut.

The core of the marshmallow treat may be infused with a liquid, such as an alcoholic beverage.

Exemplary embodiments of the present invention provide a marshmallow treat including a core which contains or is infused with one or more fillings. The marshmallow treat includes a hollow chocolate bubble surrounding the core of the marshmallow treat. The chocolate bubble is surrounded by an inner flash frozen layer sealing the chocolate bubble and fillings of the core. A partially fluffed marshmallow layer surrounds and is disposed on an outside of the inner flash frozen layer. The marshmallow layer is surrounded by an outer flash frozen layer. The outer flash frozen layer surrounds and seals the marshmallow layer.

Exemplary embodiments of the present invention provide a method for forming a marshmallow treat including forming a chocolate bubble including an inner core. Fillings are introduced into the chocolate bubble. The chocolate bubble is coated with a first uncured marshmallow gelatin mixture layer. The first uncured marshmallow gelatin mixture layer is flash frozen to form a first flash frozen layer around the chocolate bubble. A second uncured marshmallow gelatin mixture layer is coated on the first flash frozen layer to form a marshmallow layer. The marshmallow layer is allowed to partially set. The marshmallow layer is coated with a second uncured marshmallow gelatin mixture layer. The second uncured marshmallow gelatin mixture layer is flash frozen to form a second flash frozen layer around the marshmallow layer.

The fillings may include a liquid, such as an alcoholic beverage. The liquid filling may be introduced into the chocolate bubble by injecting the liquid filling through a sealed chocolate bubble.

The second uncured marshmallow gelatin mixture layer may be flash frozen by applying a cold temperature to the second uncured marshmallow gelatin mixture layer using a chilling griddle or a flash freezing griddle to form the second flash frozen layer.

The chilling griddle or flash freezing griddle may apply a cold temperature of about −30° F. to the second uncured marshmallow gelatin mixture layer to form the second flash frozen layer.

Exemplary embodiments of the present invention provide a method for forming a marshmallow treat including compounding a first mixture by simultaneously mixing and heating corn syrup and sugar. Gelatin and egg whites are mixed into the first mixture while simultaneously heating the first mixture to form a second mixture. The second mixture is strained and flavoring is added to the second mixture. The second mixture is beaten into a foam form and the foam form is extruded to deposit one or more pillow forms. Portions of the pillow forms may be flash frozen to form one or more flash frozen layers. A core may be formed in each of the pillow forms and the core may be infused with one or more fillings.

The foam form may be extruded in rope form to form one or more ropes. Each of the one or more ropes may be cut to form one or more pillow forms.

The second mixture may be extruded by a hopper. The hopper may include an automated system for flash freezing portions of the pillow form to form the one or more flash frozen layers. The automated system may form cores in the pillow forms and infuse each of the cores with the one or more fillings.

Exemplary embodiments of the present invention provide a marshmallow treat including a candy or infused center disposed inside of marshmallows coating. The marshmallow treat according to exemplary embodiments of the present invention allows the steps of heating, melting and consumption to be performed without generating food debris or a mess, which would need to be cleaned up by a person consuming a traditional marshmallow treat, such as a S'more.

### BRIEF DESCRIPTION OF THE DRAWINGS

The above and other features of the present invention will become more apparent by describing in detail exemplary embodiments thereof, with reference to the accompanying drawings in which:

FIG. 1 is a cross-sectional view of a marshmallow treat with an infused core according to an exemplary embodiment of the present invention.

FIG. 2 is a cross-sectional view of a marshmallow treat with an infused core including a chocolate bubble according to an exemplary embodiment of the present invention.

FIG. 3 illustrates a method of forming marshmallow treats with an infused core according to an exemplary embodiment of the present invention.

FIG. 4 illustrates a method of forming marshmallow treats with an infused core according to an exemplary embodiment of the present invention.

### DETAILED DESCRIPTION

Exemplary embodiments of the present invention provide a marshmallow treat including a core which contains or is infused with one or more fillings. The marshmallow treat includes an infused center and an inner flash frozen layer sealing the fillings of the infused center. A partially fluffed marshmallow layer surrounds and is disposed on an outside of the inner flash frozen layer. The marshmallow layer is surrounded by an outer flash frozen layer. The outer flash frozen layer surrounds and seals the marshmallow layer.

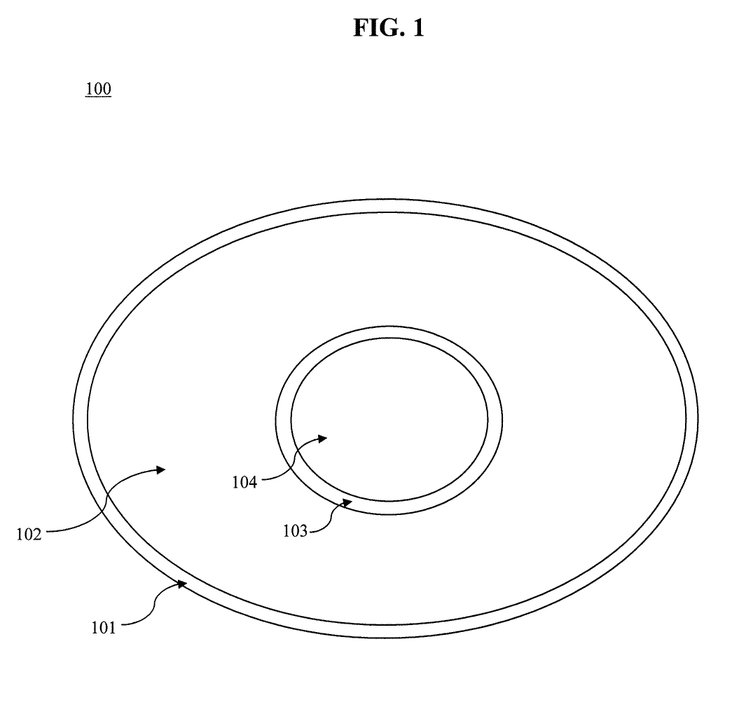

FIG. 1 is a cross-sectional view of a marshmallow treat with an infused core according to an exemplary embodiment of the present invention.

A marshmallow treat 100 may include an infused center 104, an inner flash frozen layer 103, a marshmallow layer 102 and an outer flash frozen layer 101.

The infused center 104 may be a hollow core of the marshmallow treat 100. The infused center 104 may include one or more fillings. The fillings may include for example and without limitation a cracker, candy, butterscotch, caramel, mint, vanilla, peanut Butter, hazelnut, lemon, orange, coconut, or any other desired contents. The fillings may include a liquid, such as an alcoholic beverage. For example, the alcoholic beverage may be an alcoholic beverage having a flavor profile that corresponds with flavors of other fillings, or a flavor of the marshmallow layer 102 or the flash frozen layers 101 and/or 103, such as irish cream flavored liquor, chocolate flavored liquor, or coffee flavored liquor. The alcoholic beverage may include wine or champagne.

The inner flash frozen layer 103 may be partially permeable to allow the flavors of the one or more fillings of the infused center 104 to gradually penetrate the inner flash frozen layer 103 to flavor the marshmallow layer 102.

The inner flash frozen layer 103 may be configured to prevent the fillings of the infused center 104 from spilling out when the marshmallow treat 100 is consumed.

The marshmallow layer 102 may include a partially cured marshmallow gelatin mixture. The marshmallow gelatin mixture may be configured to expand slightly or “fluff up” upon being heated. The partially cured marshmallow gelatin mixture may be only partially cooked during preparation of the marshmallow treat 100. For example, the partially cured marshmallow gelatin mixture may be cooked for 5%-75% of the traditional cooking time for a marshmallow gelatin mixture. By not fully cooking the marshmallow gelatin mixture, the cooking of the marshmallow layer 102 may be completed upon the application of heat at a later time.

The marshmallow treat 100 including the marshmallow layer 102 and the infused center 104 may be configured to be heated, for example on an open flame, to cook the marshmallow layer 102 and to heat up the infused center 104 for consumption.

The inner flash frozen layer 103 may seal the infused center 104 to preserve the fillings of the infused center 104. The outer flash frozen layer 101 may preserve the marshmallow layer and/or the infused center 104 and the inner flash frozen layer 103. Thus, the marshmallow treat 100 may be stored without refrigeration. Alternatively, the marshmallow treat 100 may be frozen or stored in a refrigerator.

The marshmallow treat 100 may be freeze dried and the freeze dried marshmallow treat 100 may be stored at room temperature or may be refrigerated or frozen for storage. The marshmallow treat 100 may be packaged in plastic wrapping and may be vacuum sealed for storage or transport.

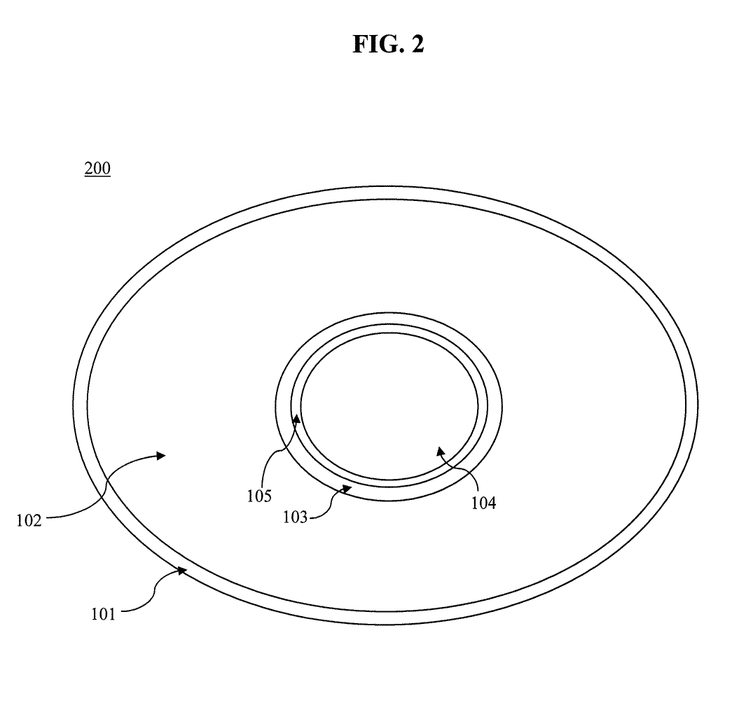

FIG. 2 is a cross-sectional view of a marshmallow treat with an infused core including a chocolate bubble according to an exemplary embodiment of the present invention.

A marshmallow treat 200 may include the infused center 104, a chocolate bubble 105, the inner flash frozen layer 103, the marshmallow layer 102 and the outer flash frozen layer 101.

The marshmallow treat 200 may be substantially the same as the marshmallow treat 100 described above with reference to FIG. 1, except for the chocolate bubble 105, and repetitious descriptions may be omitted.

The chocolate bubble 105 may include milk chocolate, fudge, white chocolate, or dark chocolate, for example. The chocolate bubble 105 may include melt-able chocolate that may be melted upon the application of heat to the layers surrounding the chocolate bubble 105, for instance, during application of an open flame to the marshmallow treat 200.

Any of the fillings disclosed herein may be disposed inside the chocolate bubble 105. The fillings (e.g., candy) disposed inside the chocolate bubble 105 may be melt-able upon the application of heat to the layers surrounding the chocolate bubble 105.

Alternatively, an edible balloon other than the chocolate bubble 105 may be disposed at a center of the marshmallow treat 200. The edible balloon may be a soy or sugar based edible balloon that may be infused with one or more fillings (e.g., by injecting one or more fillings into the edible balloon).

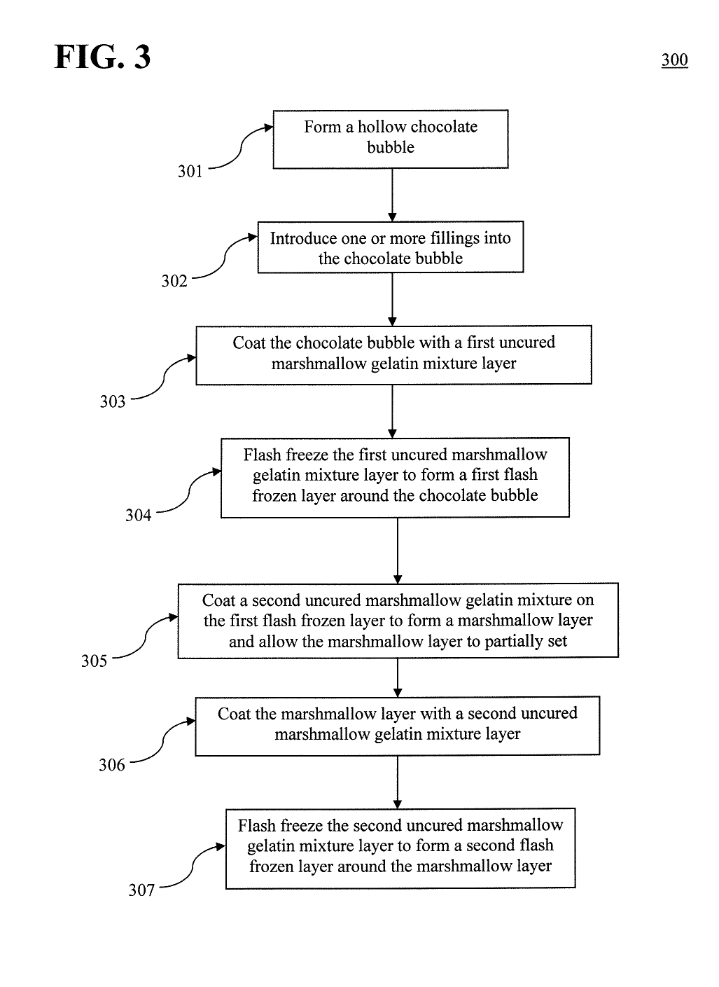

FIG. 3 illustrates a method of forming marshmallow treats with an infused core according to an exemplary embodiment of the present invention.

Referring to FIG. 3, a method 300 of forming marshmallow treats with an infused core includes forming a hollow chocolate bubble including an inner core 301. Fillings are introduced into the chocolate bubble 302. The chocolate bubble is coated with a first uncured marshmallow gelatin mixture layer 303. The first uncured marshmallow gelatin mixture layer is flash frozen to form a first flash frozen layer around the chocolate bubble 304. A second uncured marshmallow gelatin mixture layer is coated on the first flash frozen layer to form a marshmallow layer and allowed to partially set 305. The marshmallow layer is coated with a second uncured marshmallow gelatin mixture layer 306. The second uncured marshmallow gelatin mixture layer is flash frozen to form a second flash frozen layer around the marshmallow layer 307.

According to an exemplary embodiment of the present invention, the step of forming a hollow chocolate bubble including an inner core 301 may be omitted and fillings may be introduced directly into the inner flash frozen layer to form the marshmallow treat 100 illustrated in FIG. 1. The fillings may be mixed into an uncured marshmallow gelatin mixture and then flash frozen, as described below in more detail. Alternatively, an inner flash frozen layer 103 may be formed by flash freezing a marshmallow gelatin mixture to leave a hollow core and then introducing fillings to the hollow core (e.g., by injection) to form the infused center 104. The inner flash frozen layer 103 with a hollow core may be formed using a mold.

Forming a hollow chocolate bubble including an inner core 301 may include forming the chocolate bubble 105 in a mold. Fillings may be introduced into the chocolate bubble 105 to form the infused center 104. Fillings may be introduced into the chocolate bubble 105 as it is formed to form the infused center 104. For example, crackers or candy may be introduced into the chocolate bubble 105 while it is being formed. Alternatively, the chocolate bubble 105 may be formed with a hollow core and fillings may be introduced after the chocolate bubble 105 is formed. For example, a liquid such as an alcoholic beverage may be injected into the chocolate bubble 105 after it is formed, and the chocolate bubble 105 may then be sealed. According to an exemplary embodiment of the present invention, fillings may be introduced into the chocolate bubble 105 while it is being formed to leave a partially hollow core wherein additional fillings may be injected.

Coating the chocolate bubble with a first uncured marshmallow gelatin mixture layer 303 may include coating the first uncured marshmallow gelatin mixture layer onto the chocolate bubble 105. The first uncured marshmallow gelatin mixture layer is flash frozen to form a first flash frozen layer around the chocolate bubble in step 304. The first uncured marshmallow gelatin mixture layer may be flash frozen to form the inner flash frozen layer 103. Flash freezing may include dipping the chocolate bubble 105 coated in the uncured marshmallow gelatin mixture layer in liquid nitrogen. Dipping the chocolate bubble 105 coated in the uncured marshmallow gelatin mixture layer in liquid nitrogen may be done using a manual instrument or by using an automated system. According to exemplary embodiments of the present invention, flash freezing may be performed using a commercially available blast chiller. Alternatively, a standard freezer may be used to gradually chill the uncured marshmallow gelatin mixture layer to form the inner flash frozen layer 103.

A second uncured marshmallow gelatin mixture layer is coated on the first flash frozen layer to form a marshmallow layer and allowed to partially set in step 305. The second uncured marshmallow gelatin mixture layer may be coated on the first flash frozen layer 103 to form a marshmallow layer 102. The marshmallow layer 102 may be allowed to partially set so additional layers can be applied, or the marshmallow layer 102 may be partially cooked. The marshmallow gelatin mixture of the second uncured marshmallow gelatin mixture layer may be configured to expand slightly or “fluff up” upon being heated further at a later time. The partially cured marshmallow gelatin mixture may be only partially cooked during preparation of the marshmallow treat (e.g., marshmallow treats 100 or 200). For example, the partially cured marshmallow gelatin mixture may be cooked for 5%-75% of the traditional cooking time for a marshmallow gelatin mixture. By not fully cooking the marshmallow gelatin mixture, the cooking of the marshmallow layer 102 may be completed upon the application of heat at a later time. According to an exemplary embodiment of the present invention, an aeration step which is typically performed when forming a marshmallow may be skipped to allow the marshmallow gelatin mixture to remain in a more buttery or creamy form for later preparation upon the application of heat.

The marshmallow layer is coated with a second uncured marshmallow gelatin mixture layer in step 306. The marshmallow layer 102 may be coated with the second uncured marshmallow gelatin mixture layer. The second uncured marshmallow gelatin mixture layer is flash frozen to form a second flash frozen layer around the marshmallow layer in step 307. The second uncured marshmallow gelatin mixture layer may be flash frozen, as described above with regard to the inner flash frozen layer 103, to form the outer flash frozen layer 101.

The second uncured marshmallow gelatin mixture layer may be flash frozen by applying a cold temperature to the second uncured marshmallow gelatin mixture layer using a chilling griddle or a flash freezing griddle to form the outer flash frozen layer 101.

The chilling griddle or flash freezing griddle may apply a cold temperature of about −30° F./−34.4° C. to the second uncured marshmallow gelatin mixture layer, however exemplary embodiments of the present invention are not limited to these particular temperature. For example, the chilling griddle or flash freezing griddle may be configured to reach temperatures below −30° F./−34.4° C. The chilling griddle or flash freezing griddle may be configured to relatively rapidly convert sauces, cremes, purees, vinaigrettes and other foods (e.g., gelatinous or partially liquid foods) into frozen or semi-frozen foods. The flash freezing process using the chilling griddle or flash freezing griddle may form frozen or semi-frozen food substantially instantaneously or over a time period of several seconds. The flash freezing process using the chilling griddle or flash freezing griddle may form the outer flash frozen layer 101 described herein according to exemplary embodiments of the present invention.

A releasing agent, such as olive oil, may be applied to the chilling griddle or flash freezing griddle prior to placing a marshmallow treat on the chilling griddle or flash freezing griddle. The releasing agent may be applied before when the griddle is at room temperature (e.g., before reducing the temperature of the griddle). The releasing agent may be applied as a thin film, and may substantially prevent the marshmallow treat from freezing to the griddle surface.

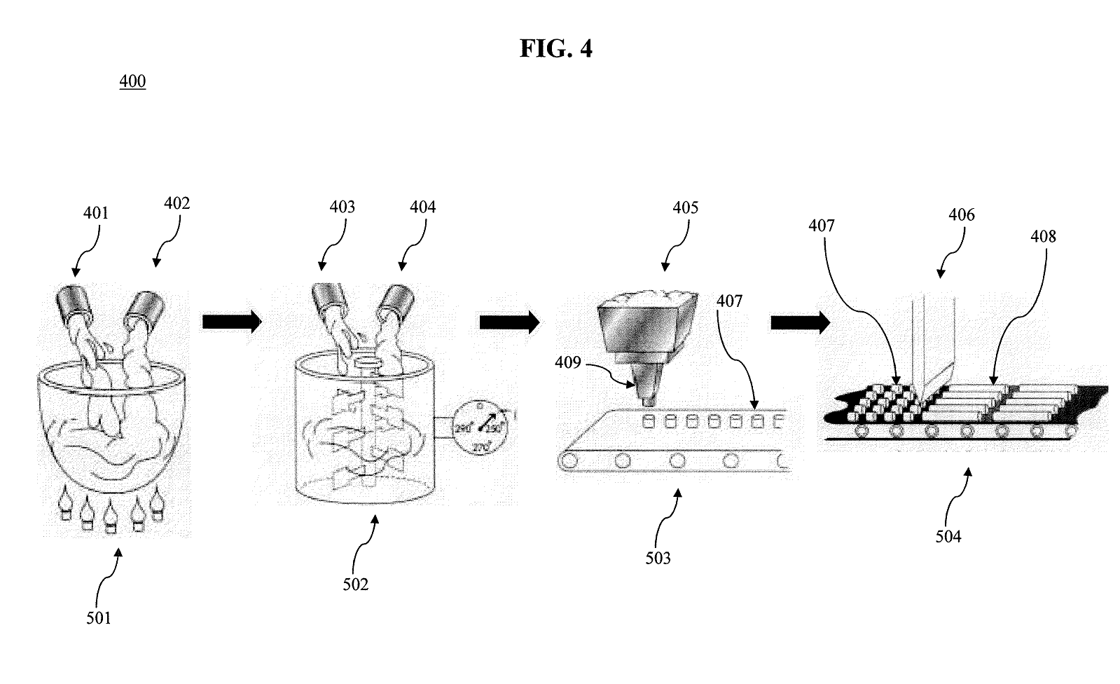

FIG. 4 illustrates a method of forming marshmallow treats with an infused core according to an exemplary embodiment of the present invention.

Referring to FIG. 4, a method 400 of forming marshmallow treats may include compounding a first mixture by simultaneously mixing and heating corn syrup 401 and sugar 402 in step 501. Gelatin 403 and egg whites 404 are mixed into the first mixture while simultaneously heating the first mixture to form a second mixture, and the second mixture is strained and flavoring is added to the second mixture in step 502. The second mixture is beaten into a foam form 407 and the foam form 407 is extruded to deposit one or more pillow forms 407 in step 503. Portions of the pillow forms 407 may be flash frozen to form one or more flash frozen layers. A core may be formed in each of the pillow forms 407 and the core may be infused with one or more fillings. The foam form 407 may be extruded in rope form 408 to form one or more ropes, and each of the one or more ropes may be cut by a cutting apparatus 406 to form one or more pillow forms in step 504.

The second mixture may be extruded by a hopper 405. The hopper 405 may include an automated system 409 for flash freezing portions of the pillow form to form the one or more flash frozen layers. The automated system 409 may form cores in the pillow forms and infuse the core with the one or more fillings.

Mixing gelatin 403 and egg whites 404 into the first mixture while simultaneously heating the first mixture to form a second mixture may be performed in a kettle maintained at about 240° F. (115° C.).

Additional ingredients may be added to the first or second mixtures, as desired, including corn syrup, sugar, corn starch, modified food starch, water, vanilla, gum, gelatin or whipped egg whites.

While the present invention has been particularly shown and described with reference to exemplary embodiments thereof, it will be understood by those of ordinary skill in the art that various changes in form and detail may be made therein without departing from the spirit and scope of the present invention.

What is claimed is:

1. A marshmallow treat, comprising:
an infused center including one or more fillings;
an inner flash frozen layer sealing the one or more fillings of the infused center;
a partially fluffed marshmallow layer surrounding and disposed on the inner flash frozen layer; and
an outer flash frozen layer surrounding and disposed on the partially fluffed marshmallow layer, wherein the outer flash frozen layer seals the partially fluffed marshmallow layer.

2. The marshmallow treat of claim 1, wherein the one or more fillings include one or more of a cracker, candy, butterscotch, caramel, mint, vanilla, peanut butter, hazelnut, lemon, orange, or coconut.

3. The marshmallow treat of claim 1, wherein the one or more fillings include a liquid.

4. The marshmallow treat of claim 3, wherein the liquid includes an alcoholic beverage.

5. The marshmallow treat of claim 1, wherein the inner flash frozen layer is sufficiently permeable to allow flavors of the one or more fillings to absorb into the partially fluffed marshmallow layer.

6. The marshmallow treat of claim 1, wherein the partially fluffed marshmallow layer is configured to expand when heated.

7. The marshmallow treat of claim 1, wherein the marshmallow treat is freeze dried.

8. A marshmallow treat, comprising:
an infused center including one or more fillings;
a chocolate bubble layer sealing the one or more fillings of the infused center;
an inner flash frozen layer surrounding and disposed on the chocolate bubble layer;
a partially fluffed marshmallow layer surrounding and disposed on the inner flash frozen layer; and
an outer flash frozen layer surrounding and disposed on the partially fluffed marshmallow layer, wherein the outer flash frozen layer seals the partially fluffed marshmallow layer.

9. The marshmallow treat of claim 8, wherein the one or more fillings include one or more of a cracker, candy, butterscotch, caramel, mint, vanilla, peanut butter, hazelnut, lemon, orange, or coconut.

10. The marshmallow treat of claim 8, wherein the one or more fillings include a liquid.

11. The marshmallow treat of claim 10, wherein the liquid includes an alcoholic beverage.

12. The marshmallow treat of claim 8, wherein the inner flash frozen layer is sufficiently permeable to allow flavors of the one or more fillings to absorb into the partially fluffed marshmallow layer.

13. The marshmallow treat of claim 8, wherein the partially fluffed marshmallow layer is configured to expand when heated.

14. The marshmallow treat of claim 8, wherein the marshmallow treat is freeze dried.

15. A method of forming a marshmallow treat, comprising:
forming a hollow chocolate bubble;
introducing one or more fillings into the hollow chocolate bubble;
coating the hollow chocolate bubble with a first uncured marshmallow gelatin mixture layer;
flash freezing the first uncured marshmallow gelatin mixture layer to form a first flash frozen layer around the chocolate bubble;
coating a second uncured marshmallow gelatin mixture on the first flash frozen layer to form a marshmallow layer and allowing the marshmallow layer to partially set;
coating the marshmallow layer with a second uncured marshmallow gelatin mixture layer; and
flash freezing the second uncured marshmallow gelatin mixture layer to form a second flash frozen layer around the marshmallow layer.

16. The method of forming a marshmallow treat of claim 15, wherein the hollow chocolate bubble is sealed, and wherein one or more fillings are injected into the sealed hollow chocolate bubble.

17. The method of forming a marshmallow treat of claim 15, wherein flash freezing the first and second uncured marshmallow gelatin mixture layers includes applying a cold temperature to the first and second uncured marshmallow gelatin mixture layer using a chilling griddle or a flash freezing griddle.

18. The method of forming a marshmallow treat of claim 17, wherein the cold temperature is about −30° F. or less.

19. The marshmallow treat of claim 15, wherein the one or more fillings include one or more of a cracker, candy, butterscotch, caramel, mint, vanilla, peanut butter, hazelnut, lemon, orange, or coconut.

20. The marshmallow treat of claim 10, wherein the one or more fillings includes an alcoholic beverage.
